(19) United States
(12) Patent Application Publication
(10) Pub. No.: US 2013/0062846 A1
(43) Pub. Date: Mar. 14, 2013

(54) COLLAPSIBLE FRAME STRUCTURE OF SCOOTER

(71) Applicant: CHEN-CHI HSIAO, CHIA YI CITY (TW)

(72) Inventor: CHEN-CHI HSIAO, CHIA YI CITY (TW)

(73) Assignee: SUNPEX TECHNOLOGY CO., LTD., CHIA YI CITY (TW)

(21) Appl. No.: 13/228,533

(22) Filed: Sep. 9, 2011

(51) Int. Cl. B62M 1/00

(52) U.S. Cl. 280/87.05

(57) ABSTRACT

A collapsible frame structure of a scooter is provided with a front and a rear frame mutually overlapped with each other and a collapsible unit is provided at the abutment between the front and the rear frame. The collapsible unit includes two connecting plates provided respectively at both sides of the front and the rear frames. Both ends of each connecting plate are pivotally connected respectively to the front and the rear frames. Further, latches and strikes capable of locking correspondingly with each other are respectively provided at both sides of the front and the rear frames. By this simple-design collapsible unit, manufacturing cost of the collapsible frame structure of scooter can be decreased, unfolding and collapsing of the front and the rear frame can be facilitated and robustness after the unfolding of the front and the rear frames can be ensured.

### BACKGROUND OF INVENTION

1. Field of the Invention

The present invention relates to a collapsible frame structure of a scooter, more particularly to a collapsible frame structure having low cost, convenient usage and robustness in structure, of a scooter.

2. Brief Description of the Prior Art

Generally, scooter can provide users with convenience of long-distance travel. However, because of its non-collapsible structure, a relatively large space will be taken when the scooter is not in use. Therefore, users often suffer from inconvenience in its transportation and storage. For this reason, the relevant industries have proposed unfolding and collapsing structure for a scooter in such a manner that the scooter can be collapsed to reduce its volume for compact storage and improved portability purpose. However, current collapsible frame of scooter is relatively complicated in its structure and the manufacturing cost thereof is rather high. Besides, screws and bolts are often used as fastening parts for the unfolding and the collapsing of a scooter in most cases, and it takes much time in tightening and untightening of the screws and the bolts so that it is time consuming hard sledding in the unfolding and the collapsing of a scooter. In addition, fastening parts like screws and bolts are easy to be loosened by the vibration occurred when the scooter is jolted badly on a rough road. Hence, there might be a risk that the frame of the scooter is automatically collapsed. Therefore, there is still space for improvement on the collapsible frame structure of scooter.

### SUMMARY OF THE INVENTION

The present invention relates to a collapsible frame structure of a scooter, more particularly to a collapsible frame structure having low cost, convenient usage and robustness in structure, of a scooter.

In order to achieve the above objects, the inventor of the present invention proposes a collapsible frame structure of a scooter, wherein the collapsible frame is provided with a front frame with a rear frame overlapped thereon, a collapsible unit being provided at the abutment between the front and the rear frames, the collapsible unit including two connecting plates provided respectively at both sides of the front and the rear frames, both ends of each connecting plate being pivotally connected respectively to the front and the rear frames; latches and strikes, capable of locking correspondingly with each other, being respectively provided at both sides of the front and the rear frames.

By this simple-design collapsible unit, manufacturing cost of the collapsible frame structure of scooter can be decreased, unfolding and collapsing of the front and the rear frame becomes very easy and robustness after the unfolding of the front and the rear frame can be ensured.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view showing the whole structure of the present invention;

FIG. 2 is a perspective view showing the collapsing unit of the present invention;

FIG. 3 is a sectional view showing the collapsing unit of the present invention;

FIG. 4 is a sectional view showing the seat of the present invention;

FIG. 5 is a perspective exploded view showing the steering handlebar of the present invention;

FIG. 6 is view showing a partial collapsing state of the present invention;

FIG. 7 is a view showing the whole collapsing state of the present invention.

### DETAILED DESCRIPTION OF THE PREFERRED EMBODIMENT

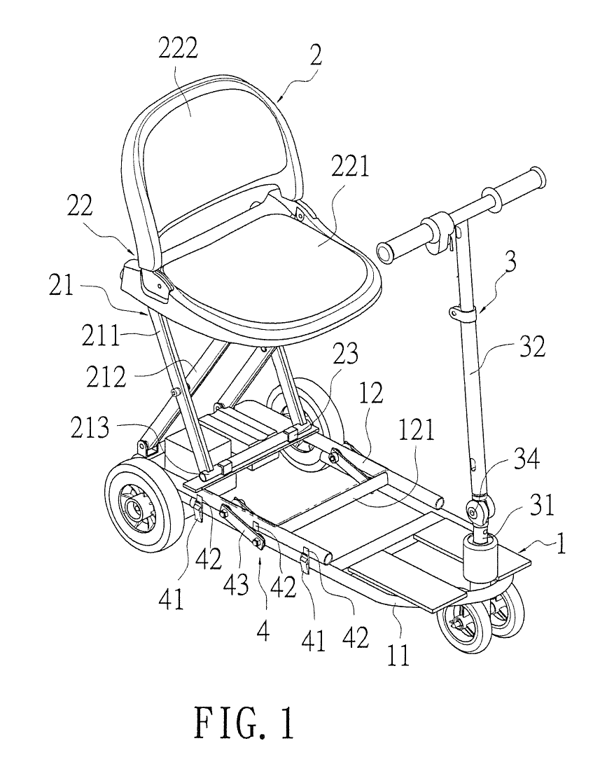

Firstly referring to FIGS. 1 to 3, the collapsible frame structure of scooter of the present invention comprises functions of collapsing a frame major body (1), a seat (2) and a steering handlebar (3).

The frame major body (1) has a front frame (11) with a rear frame (12) overlapped thereon and a pulling rod (121) is provided between both sides of the rear frame (12). A collapsible unit (4) is provided at the abutment between the front and the rear frames (11), (12), the collapsible unit (4) including two connecting plates (43) provided respectively at both sides of the front and the rear frames (11), (12). Both ends of each connecting plate (43) are pivotally connected respectively to the front and the rear frames (11), (12). Latches (41) and strikes (42), capable of locking correspondingly with each other, are respectively provided at both sides of front and the rear frames (11), (12). According to this invention, two strikes (42) are respectively provided at a front and a rear positions of the rear frame (12), whereas two latches (41) corresponding to the strikes (42) of the rear frame (12) are provided at a front and a rear positions of the front frame (11). According to a preferred embodiment, an additional strike (42) is provided between the front and the rear strikes (42) of the rear frame (12). Each latch (41) has a fixing plate (411) anchored on the rear frame (12), a handle (412) being pivotally connected to the fixing plate (411) and a spring element (413) being provided at the pivotal joint between the fixing plate (411) and the handle (412); a wire loop (414) being assembled on the handle (412) for locking with a hook portion (421) of the strike (42) provided on the rear frame (12).

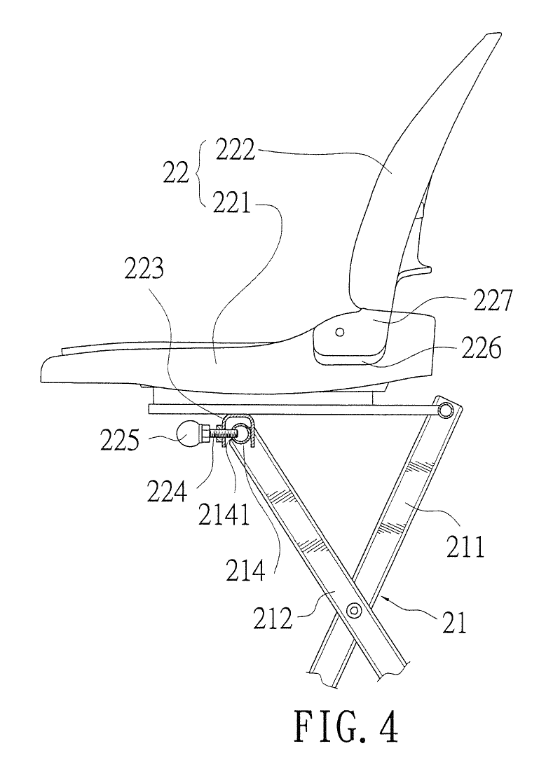

Referring also to FIG. 4, the seat (2) includes a seat section (22) and two support leg units (21) provided at both sides of the seat section (22). Each support leg unit (21) includes a first link (211) and a second link (212) intersecting with each other and hinged together at the intersection point; the ends near the rear sides of the seat section (22), of the first link (211) and the second link (212) being pivotally connected to the rear edges of the rear frame (12) and a chair (221) of the seat section (22) respectively, while the ends near the front sides of the seat section (22), of the first link (211) and the second link (212) being respectively connected to a third link (213) and a fourth link (214), which are both provided between the first link (211) and the second link (212) and correspond to the front side of the seat section (22). The third link (213) is received in engaging slots (23) provided at the front edge of the rear frame (12) and is engaged therewith. On the other hand, the fourth link (214) is received in an abutting groove (223) provided at the bottom front edge of the chair (221) of the seat section (22) and is engaged therewith. Pin holes corresponding to each other (224), (2141) are respectively provided on the abutting groove (223) and the fourth link (214), and a pin (225) is assembled in the pin hole (224) of the abutting groove (223) so as to penetrate through pin holes (224), (2141) on the abutting groove (223) and the fourth link (214). In addition to the chair (221), the seat section (22) includes a seat back (222) which is pivotally provided on the chair (221). At the pivot joints of the chair (221) and the seat back (222), engaging recesses (226) are provided on the chair (221) for locking with engaging portions (227) provided on the seat back (222) so as to keep a backward tilt state of the seat back (222).

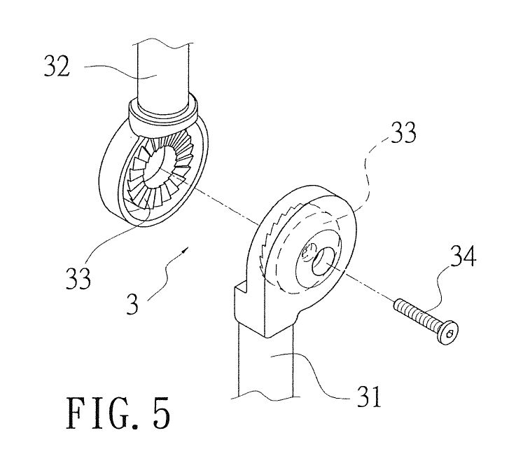

Referring also to FIG. 5, the steering handlebar (3) is assembled at the front part of the front frame (11). The steering handlebar (3) includes a connecting rod (31) fixed on the front frame (11) and a headtube (32) which is pivotally connected to the connecting rod (31). Ratchet wheel portions (33) engaging with each other are respectively provided on the pivotal joint faces of the connecting rod (31) and the headtube (32), and a fastening member (34) is utilized to penetrate through the pivot joint of the headtube (32) and the connecting rod (31) for fixing.

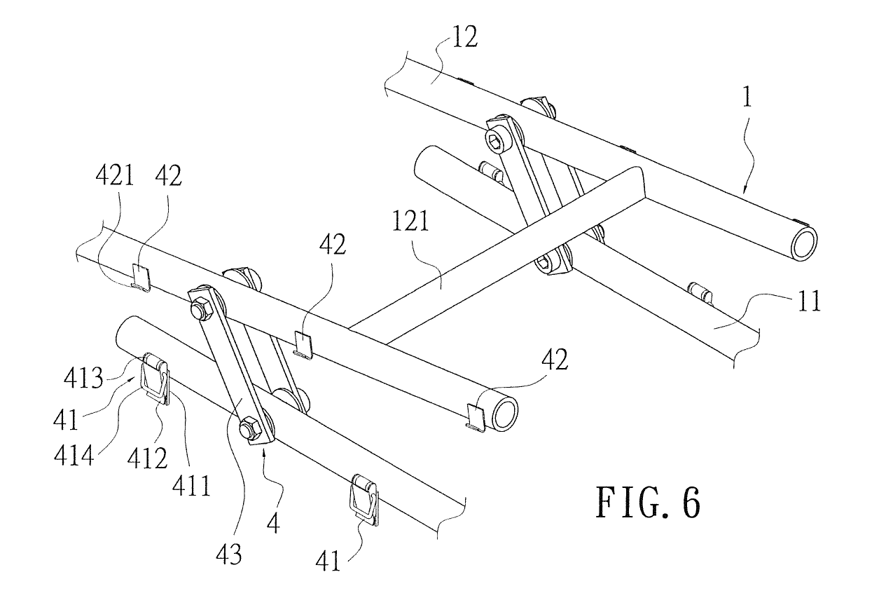

Next, the processes of collapsing and unfolding of the scooter will be describer according to the above configuration. Before the transportation or storage of the scooter, it is collapsed to reduce its volume. Referring also to FIG. 6, the latches (41) and the strikes (42) of the collapsing unit (4) are released to free the mutual fastening between the front frame (11) and the rear frame (12) so that the front frame (11) and the rear frame (12) are able to move relative to each other.

In turn, the pulling rod (121) provided between both sides of the rear frame (12) is pulled to turn upward by user's hands and is then pushed toward the front of the front frame (11) to close up therewith so that the rear frame (12) and the seat section (22) provided thereon are folded to the front portion of the front frame (11). At this moment, the two connecting plates (43) provided respectively at both sides of the front and the rear frames (11), (12) follow the movement of the rear frame (12) and are closed up toward the front part of the front frame (11) so that the connecting plates (43) change from backward tilt state to forward tilt state so as to keep good connection relationship between the front frame (11) and the rear frame (12). At this moment, one strike (42) provided on the rear frame (12) is align with a latch (41) provided on the front frame (11) so that the wire loop (414) of the latch (41) can be locked on the hook portion (421) of the strike (42). Further, the spring element (413) provided at the pivotal joint between the fixing plate (411) and the handle (412) is utilized to tighten up the wire loop (414) assembled on the handle (412) so that the wire loop (414) can be securely locked on the strike (42) so as to secure the collapsing state of the scooter.

Next, referring also to FIG. 4, the pin (225) assembled in the abutting groove (223) provided at the bottom of the chair (221) of the seat (2) is pulled out so as to release the locking with the pin hole (2141) of the fourth link (214). Hence, the seat section (22) can be turned upward so that the fourth link (214) received and engaged in the abutting groove (223) of the chair (221) can be disengaged from the abutting groove (223). In turn, the locking of the support leg units (21) can be released after the liberation of the fourth link (214). At this moment, the third link (213) assembled at the bottom end of the first link (211) can be pulled out from the engaging slots (23) provided at the front edge of the rear frame (12), then the first link (211) and the second link (212) intersecting with each other and hinged together can be overlapped with each other so that the seat section (22) can be lowered down onto the rear frame (12) and simultaneously the seat back (222) of the seat section (22) can be turned downward to flush with the chair (221).

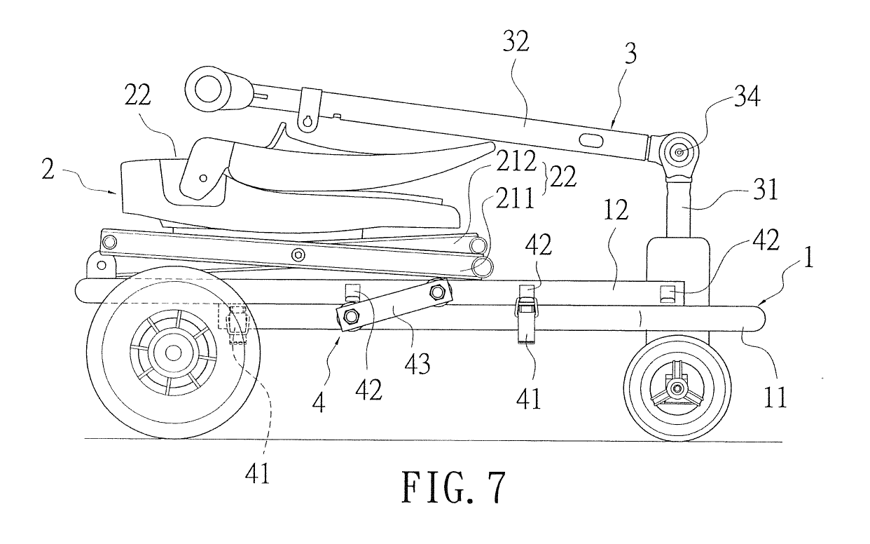

Next, referring also to FIG. 7, the fastening member (34) at the pivot joint of the headtube (32) and the connecting rod (31) is released so that the headtube (32) can be lay down onto the seat (2) above the front and the rear frame (11), (12) already overlapped and closed up together. In this manner, the collapsing action of the frame (1) and the seat (2) is finished in simple manner and then the volume of the whole scooter is effectively decreased so as to achieve better effect on both storage and transportation of the scooter.

On the other hand, when users want to drive the scooter, referring also to FIG. 7, users only need to take up abovementioned steps in reverse direction. That is to say, the headtube (32) of the steering handlebar (3) is turned upward to the vertical fixed position; in turn, the fastening member (34) assembled at the pivot joint of the headtube (32) and the connecting rod (31) is tightened to lock up so that the ratchet wheel portions (33) provided on the pivotal joint faces of the connecting rod (31) and the headtube (32) are engaged with each other so as to secure the headtube (32) in fixed position, as shown in FIG. 5.

Next, as shown in FIG. 4, the seat section (22) is pulled upward so that the first links (211) and the second links (212) of the support leg units (21) provided at the bottom of the seat section (22) are simultaneously unfolded to change from overlapped state into intersecting state. Further, the third link (213) connected to the bottom end of the first link (211) is engaged in the engaging slots (23) provided at the front edge of the rear frame (12) so as to lock the first link (211) and the third link (213) in places. Then, the fourth link (214) connected with the upper ends of the second link (212) is received and is engaged in an abutting groove (223) provided at the bottom side of the chair (221) of the seat section (22). At this moment, the pin (225) assembled in the abutting groove (223) is temporarily pulled out in advance, and it is inserted through the pin holes (224), (2141) of the abutting groove (223) and the fourth link (214) again immediately after the fourth link (214) is received in the abutting groove (223) so that the fourth link (214) is secured in the abutting groove (223) of the chair (221). In this manner, the seat section (22) can be securely supported by the support leg units (21).

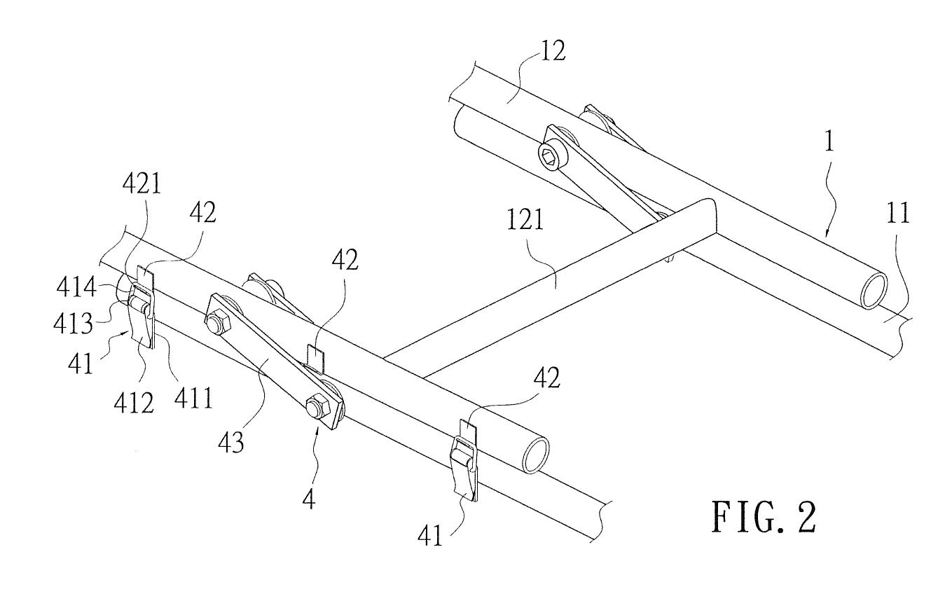

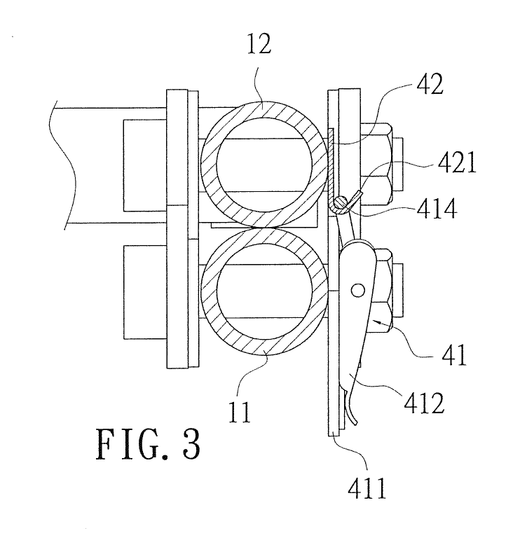

In turn, referring also to FIG. 2, the pulling rod (121) provided between both sides of the rear frame (12) is pulled backward by user's hands so that the rear frame (12) and the seat (2) provided thereon are unfolded. At the same time, the two connecting plates (43) provided respectively at both sides of the front and the rear frames (11), (12) change from forward tilt state to backward tilt state. When the rear frame (12) is pulled backward to its fixed position, the latches (41) of the front frame (11) align with the corresponding strikes (42) of the rear frame (12) so that the wire loops (414) of the latches (41) are easily to be locked on the hook portions (421) of the strikes (42), as shown in FIG. 3. Then, the spring elements (413) provided at the pivotal joints between the fixing plates (411) and the handles (412) restores their positions to tighten up the wire loops (414) assembled on the handles (412) so that the wire loops (414) can be securely locked on the strikes (42). In this manner, the front and the rear frames (11), (12) can be secured in their unfolded state under the firm locking between the latches (41) and the strikes (42) so that users can drive the scooter safely.

What is claimed is:

1. A collapsible frame structure of scooter, comprising a front frame with its rear portion overlapped by a rear frame, a collapsible unit being provided at the abutment between said front and said rear frames, said collapsible unit including two connecting plates provided respectively at both sides of said front and said rear frames, both ends of each said connecting plate being pivotally connected respectively to said front and said rear frames; latches and strikes capable of locking correspondingly with each other being respectively provided at both sides of said front and said rear frames.

2. The collapsible frame structure of scooter as claimed in claim 1, wherein each said latch includes a fixing plate anchored on said rear frame and a handle pivotally connected to said fixing plate; a spring element being provided at the pivotal joint between said fixing plate and said handle and a wire loop being assembled on said handle for locking on a hook portion formed on said strike provided on said rear frame.

3. The collapsible frame structure of scooter as claimed in claim 2, wherein two strikes are respectively provided at a front and a rear positions of said rear frame, whereas two latches corresponding to said two strikes of said rear frame are provided at a front and a rear positions of said front frame; an additional strike being provided between said front and said rear strikes of said rear frame.

4. The collapsible frame structure of scooter as claimed in claim 3, wherein said collapsing unit further has a pulling rod provided between both sides of said rear frame.

5. The collapsible frame structure of scooter as claimed in claim 4, wherein said collapsible frame structure of scooter further comprises the function of collapsing a seat which includes a seat section and two support leg units provided at both sides of said seat section; each support leg unit including a first link and a second link intersecting with each other and hinged together at the intersection point; the ends near the rear sides of said seat section, of said first link and said second link being pivotally connected to the rear edges of said rear frame and a chair of said seat section respectively, while the ends near the front sides of said seat section, of said first link and said second link being respectively connected to a third link and a fourth link, which are both provided between said first link and said second link and correspond to said front side of said seat section; said third link being received in engaging slots provided at the front edge of said rear frame and being engaged therewith; on the other hand, said fourth link being received in an abutting groove provided at the bottom front edge of said chair of said seat section and being engaged therewith.

6. The collapsible frame structure of scooter as claimed in claim 5, wherein pin holes corresponding to each other are respectively provided on said abutting groove and said fourth link and a pin is assembled in said abutting groove in such a manner as to penetrate through said pin holes respectively provided on said abutting groove and said fourth link.

7. The collapsible frame structure of scooter as claimed in claim 6, wherein said seat section includes a chair and a seat back which is pivotally provided on said chair; at the pivot joints of said chair and said seat back, engaging recesses are further provided on said chair for locking with engaging portions provided on said seat back.

8. The collapsible frame structure of scooter as claimed in claim 7, wherein said collapsible frame structure of scooter further comprises the function of collapsing a steering handlebar which includes a connecting rod fixed on said front frame and a head tube pivotally connected to said connecting rod; a fastening member is further provided to penetrate through said pivotal joint faces of said connecting rod and said headtube for fixing.

9. The collapsible frame structure of scooter as claimed in claim 8, wherein ratchet wheel portions engaging with each other are respectively provided on said pivotal joint faces of said connecting rod and said headtube.

10. The collapsible frame structure of scooter as claimed in claim 1, wherein two strikes are respectively provided at a front and a rear positions of said rear frame, whereas two latches corresponding to said two strikes of said rear frame are provided at a front and a rear positions of said front frame; an additional strike being provided between said front and said rear strikes of said rear frame.

11. The collapsible frame structure of scooter as claimed in claim 1, wherein said collapsing unit further has a pulling rod provided between both sides of said rear frame.

12. The collapsible frame structure of scooter as claimed in claim 1, wherein said collapsible frame structure of scooter further comprises the function of collapsing a seat which includes a seat section and two support leg units provided at both sides of said seat section; each support leg unit including a first link and a second link intersecting with each other and hinged together at the intersection point; the ends near the rear sides of said seat section, of said first link and said second link being pivotally connected to the rear edges of said rear frame and a chair of said seat section respectively, while the ends near the front sides of said seat section, of said first link and said second link being respectively connected to a third link and a fourth link, which are both provided between said first link and said second link and correspond to said front side of said seat section; said third link being received in engaging slots provided at the front edge of said rear frame and being engaged therewith; on the other hand, said fourth link being received in an abutting groove provided at the bottom front edge of said chair of said seat section and being engaged therewith.

13. The collapsible frame structure of scooter as claimed in claim 12, wherein pin holes corresponding to each other are respectively provided on said abutting groove and said fourth link and a pin is assembled in said abutting groove in such a manner as to penetrate through said pin holes respectively provided on said abutting groove and said fourth link.

14. The collapsible frame structure of scooter as claimed in claim 13, wherein said seat section includes a chair and a seat back which is pivotally provided on said chair; at the pivot joints of said chair and said seat back, engaging recesses are further provided on said chair for locking with engaging portions provided on said seat back.

15. The collapsible frame structure of scooter as claimed in claim 1, wherein said collapsible frame structure of scooter further comprises the function of collapsing a steering handlebar which includes a connecting rod fixed on said front frame and a headtube pivotally connected to said connecting rod; a fastening member is further provided to penetrate through said pivotal joint faces of said connecting rod and said headtube for fixing.

16. The collapsible frame structure of scooter as claimed in claim 15, wherein ratchet wheel portions engaging with each other are respectively provided on said pivotal joint faces of said connecting rod and said headtube.
